(19) United States
(12) Patent Application Publication
(10) Pub. No.: US 2014/0056669 A1
(43) Pub. Date: Feb. 27, 2014

(54) CONCRETE BOLT ASSEMBLY

(71) Applicant: TAI-PING HSU, KAOHSIUNG COUNTY (TW)

(72) Inventor: TAI-PING HSU, KAOHSIUNG COUNTY (TW)

(73) Assignee: YOW CHENG CO., LTD., KAOHSIUNG COUNTY (TW)

(21) Appl. No.: 13/598,940

(22) Filed: Aug. 30, 2012

(30) Foreign Application Priority Data
Aug. 23, 2012 (TW) 101216291

(51) Int. Cl. F16B 35/06

(52) U.S. Cl. 411/397; 411/396

(57) ABSTRACT

A concrete bolt assembly comprises a bolt set and a spherical washer for the bolt set to penetrate. The bolt set includes a concrete bolt member and a spherical nut disposed on the concrete bolt member. The spherical nut has a first sphere and the spherical washer has a second sphere. With the arrangement of the first sphere and the second sphere, the concrete bolt assembly can be embedded in a building material from any inclined angle since the contact of the spherical nut and the spherical washer exerts a perpendicular force to densely tighten the concrete bolt assembly, prevent the embedded concrete bolt assembly from easily corning off or extracting front the building material after screwing, and enhance an engaging effect of the assembly.

### BACKGROUND OF THE INVENTION

1. Field of the Invention

The present invention relates to a concrete bolt, particularly to a concrete bolt assembly comprising a spherical washer and a spherical nut.

2. Description of the Related Art

Referring to FIGS. 1 and 2, a conventional concrete bolt assembly 1 comprises a concrete bolt member 11, a nut 12 disposed on the concrete bolt member 11, and a washer 13 disposed under the nut 12. Wherein, the concrete bolt member 11 includes a shank 111, and a threaded section 112 disposed around the shank 111. Herein, the nut 12 is a hexagonal formation and has a flat plane 121. Further, the washer 13 defines an opening 131 for the concrete holt member 11 to penetrate.

Accompanying with FIG. 2, the concrete bolt assembly 1 is utilized to fix an object 4 into a building material 2 (such as concrete). In screwing, a predrilled hole 21 is defined on a proper position of the concrete 2. Accordingly, when the shank 111 of the concrete bolt member 11 penetrates the washer 13 and enters the predrilled hole 21, a wrench (not shown) is exerted to screw the concrete holt assembly 1. When the nut 12 touches the washer 13, the concrete bolt member 11 starts to be firmly engaged in the predrilled hole 21, so that the object 4 is fixed to the concrete 2.

However, there are shortcomings existing in the conventional concrete bolt assembly 1:

1. When the concrete bolt member 11, the flat plane 121 of the nut 12, and the washer 13 contact with each other in a planar way, there is no room for the concrete bolt member 11 to be freely adjusted. Namely, if the concrete bolt member 11 is screwed askew, an interstice P is adversely occurred among the concrete bolt member 11, the nut 12, and the washer 13, or between the washer 13 and the object 4. As a result, foreign substances or moisture may get into the interstice P, which easily corrodes the concrete bolt assembly 1 and reduces using life thereof.

2.If the concrete bolt assembly 1 is improperly struck or screwed askew in order to be fastened more firmly, the predrilled hole 21 may be broken, and the structure as well as the strength of the concrete 2 may be destroyed. Consequently, the concrete bolt assembly 1 provides a poor fastening effect, which needs amendments.

3. The planar structures of the nut 12 and the washer 13 are easily vibrated by accidental external influence. Subsequently, the concrete bolt member 11 and the nut 12 are influenced and they may easily retract out of the predrilled hole 21.

### SUMMARY OF THE INVENTION

The object of the present invention is to provide a concrete bolt assembly that can be firmly fastened by an advanced engaging force.

The concrete bolt assembly in accordance with the present invention comprises a bolt set and a spherical washer disposed on the bolt set. The bolt set includes a concrete bolt member and a spherical nut disposed on the concrete bolt member. Wherein, the concrete bolt member has a shank, and a first threaded section disposed, on the shank, opposite to the spherical nut. The spherical nut has a head portion formed with respect to a central axis, a first, top plane formed on the head portion, and a first bottom plane formed opposite to the first top plane. The first bottom plane is forced into a first, sphere configuration, and a center of the first sphere is situated on the central axis. In addition, the spherical washer has a washer body, a second top plane formed on the washer body, and a second bottom plane disposed opposite to the second top plane. Wherein, an opening is defined on the washer body for the shank of the concrete bolt member to penetrate. A second sphere, corresponding to the first sphere, is formed on the second top plane, and a center of the second sphere is situated on the central axis.

Preferably, the concrete bolt member and the spherical nut are separated; on the shank of the concrete bole member, a neck is formed opposite to the first threaded section, a polygonal section is disposed above the neck, and a second threaded section is surrounded between the first threaded section and the neck; the spherical nut defines a threaded hole around the center of the first sphere for coupling to the second threaded section.

Preferably, the polygonal section is a hexagonal section.

Preferably, a pitch of the first threaded section is larger than a pitch of the second threaded section.

Preferably, a plurality of slots are defined on the second bottom plane of the spherical washer, so that a periphery of the second bottom plane is indented by forming a plurality of teeth units thereon.

Preferably, a radian of the first sphere of the spherical nut and a radian of the second sphere of the spherical washer are different.

Accordingly, the spherical nut and the spherical washer are able to firmly contact with each other in any engaging angle during screwing the concrete bolt assembly. Namely, no interstice is incurred, and the concrete bolt assembly stably fastens an object by means of a perpendicular screwing force. Favorably, the engaging angle does not influence the fastened state and the structure strength of the object. Thereby, the concrete bolt assembly achieves a firm fastening effect.

### BRIEF DESCRIPTION OF THE DRAWINGS

FIG. 1 is a schematic view showing a conventional concrete bolt assembly;

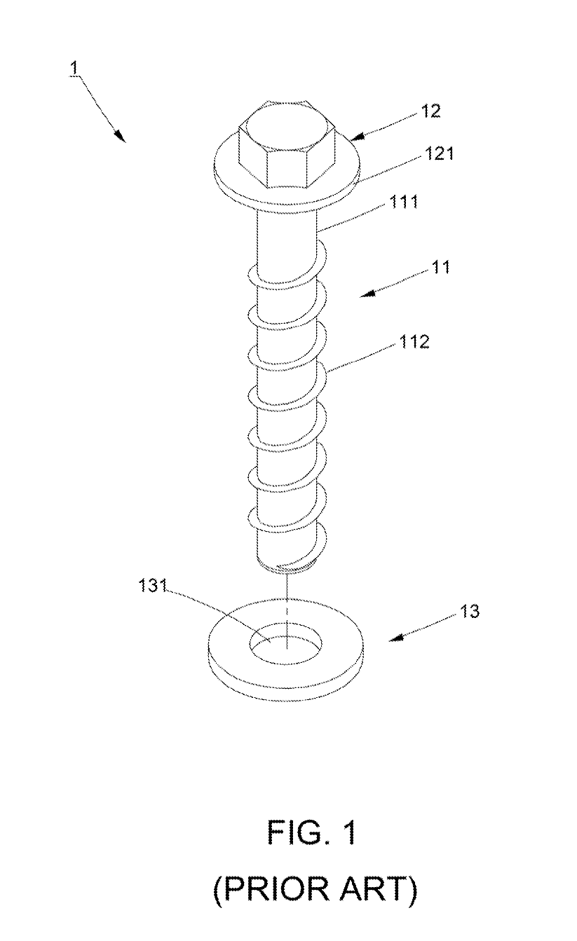

FIG. 2 is a schematic view showing the conventional, concrete bolt assembly in operation;

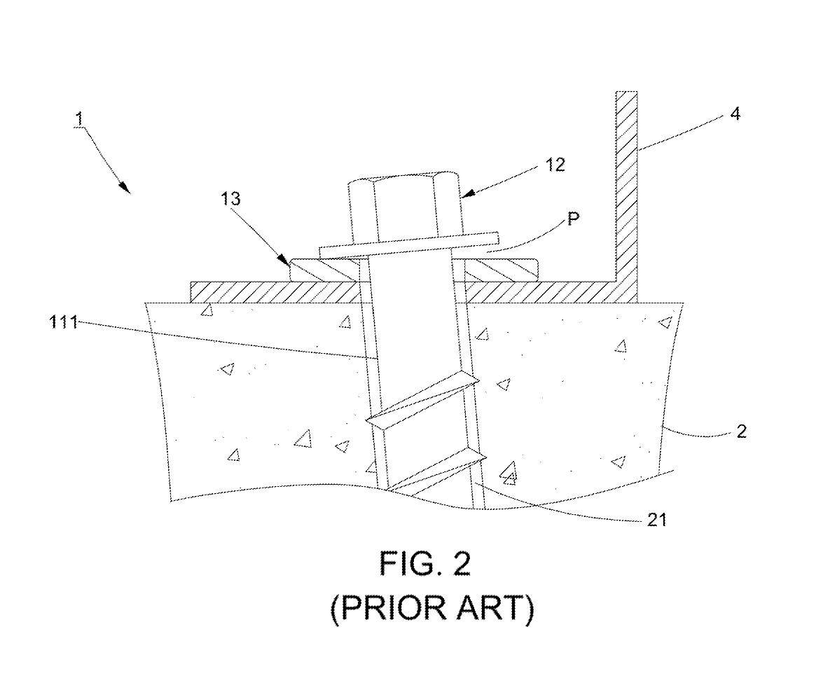

FIG. 3 is a schematic view showing a first preferred embodiment of the present invention;

FIG. 4 is a schematic view showing the first preferred embodiment of the present invent ion in operation;

FIG. 5 is a schematic view showing a second preferred embodiment of the present invention;

FIG. 6 is a schematic view showing the second preferred embodiment of the present invention in operation;

FIG. 7 is another schematic view showing the second preferred embodiment of the present invention in operation;

FIG. 8 is a schematic view showing the second preferred embodiment of the present invention in screwing; and

FIG. 9 is a schematic view showing a third preferred embodiment of the present invention.

### DETAILED DESCRIPTION OF THE PREFERRED EMBODIMENTS

Before the present invention is described in greater detail, it should be noted that the like elements are denoted by the same reference numerals throughout the disclosure.

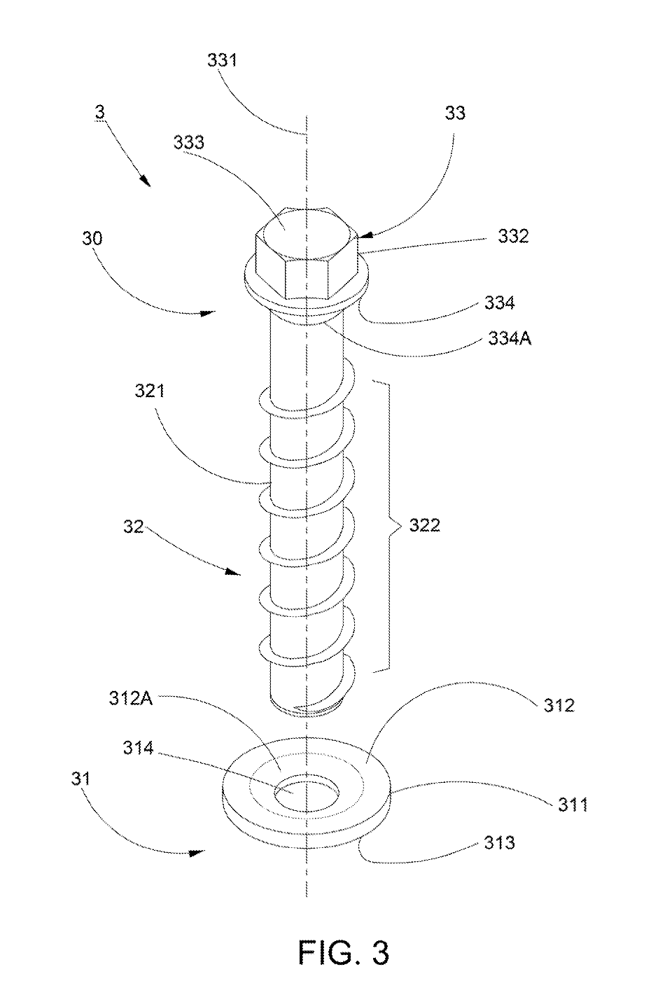

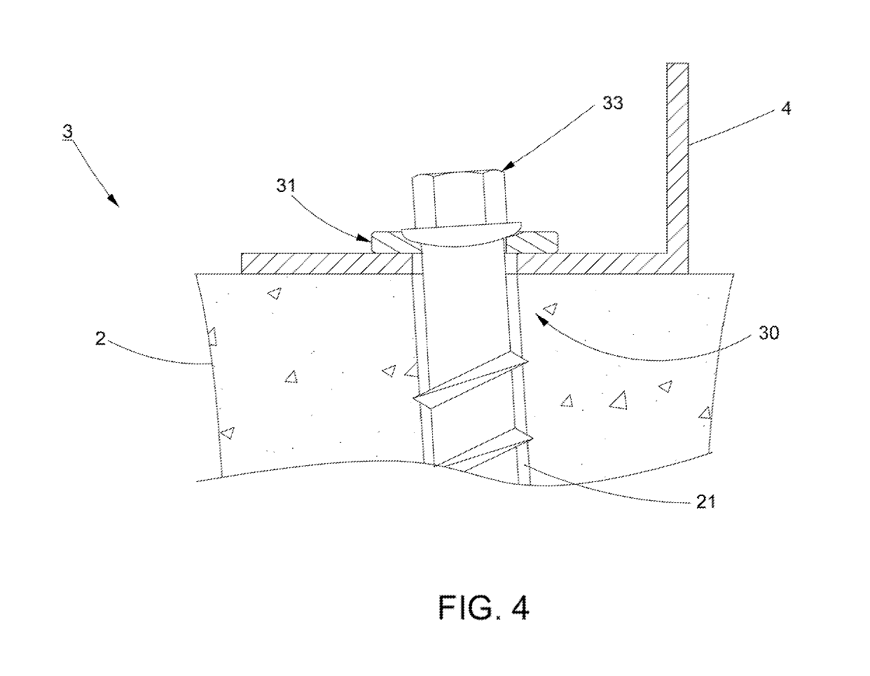

FIGS. 3 and 4 show a first preferred embodiment of the present invention. A concrete bole assembly 3 is utilized to fasten an object 4 to a building material 2, such as concrete. The concrete bolt assembly 3 comprises a bolt set 30 and a spherical washer 31 for the bolt set 30 to penetrate. Wherein, the bolt set 30 includes a concrete bolt member 32 and a spherical nut 33 disposed on the concrete holt member 32. The concrete bolt member 32 has a shank 321, and a first threaded section 322 disposed on the shank 321, opposite to the spherical nut 33. The spherical nut 33 has a hexagonal head portion 332 formed with respect to a central axis 331, a first top plane 333 formed on the head portion 332, and a first bottom, plane 334 formed opposite to the first top plane 333. The first bottom plane 334 is formed into a first sphere 334A, and a center of the first sphere 334a is situated on the central axis 331. Further, the spherical washer 31 is disposed on the bolt set 30, The spherical washer 31 has a washer body 311, a second top plane 312 formed on the washer body 311, and a second bottom plane 313 disposed opposite to the second top plane 312. Wherein, an opening 314 is defined in accordance with the central axis 331 on the washer body 311 for the shank 321 of the concrete bolt member 32 to penetrate. Moreover, a second sphere 312a, corresponding to the first sphere 334A, is formed on the second top plane 312, and a center of the second sphere 312A is also situated on the central axis 331.

Accompanying with FIG. 4, in using, the object 4 is to be fixed to the building material 2 (such as concrete). Firstly, a predrilled hole 21 is formed at a proper position of the concrete 2. Afterward, when the bolt set 30 penetrates the spherical washer 31, a wrench is further exerted to screw the concrete bolt assembly 3. After the spherical nut 33 touches the spherical washer 31, the bolt set 30 starts to be firmly engaged in the predrilled hole 21. Accordingly, the object 4 is fixed to the concrete 2.

Herein, since the spherical washer 31 and the spherical nut 33 respectively have the first sphere 334A and the second sphere 312A, the spherical washer 31 and the spherical nut 33 can firmly contact each other even the bolt set 30 is fastened in an inclined angle. Preferably, there is no interstice incurred between the spherical nut 33 and the spherical washer 31 or between the spherical washer 31 and the object 4; namely, the room among the spherical nut 33, the spherical washer 31, and the object 4 is completely closed as figured. As a result, foreign substances and moisture are prevented from getting into the bolt set 30 and the predrilled hole 21, so that the concrete bolt assembly 3 will not be corroded. In fact, since the centers or the first sphere 334A and the second sphere 312A are situated on the same central axis 331, a perpendicular engaging force is resulted along the central axis 331 for firmly constraining the concrete bolt member 32 while the spherical washer 31 and the spherical nut 33 contact each other in time of screwing, Whereby, the perpendicular engaging force allows a more stable fastening effect of the concrete bolt assembly 1 to be achieved. Favorably, even the concrete bolt member 32 enters the concrete 2 along the inclined angle, the stable and firmly engaging force avoids breaking the concrete 2. Concurrently, the fastened concrete bolt assembly 3 will not be withdrawn by any accidental external vibration; obviously, the fastening effect of the present invention is largely enhanced.

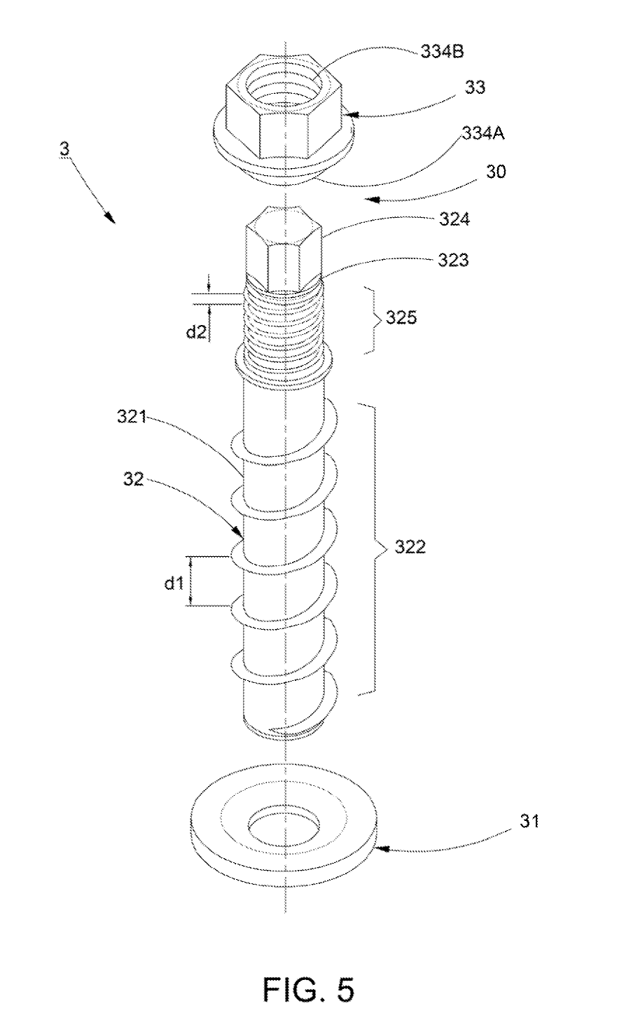

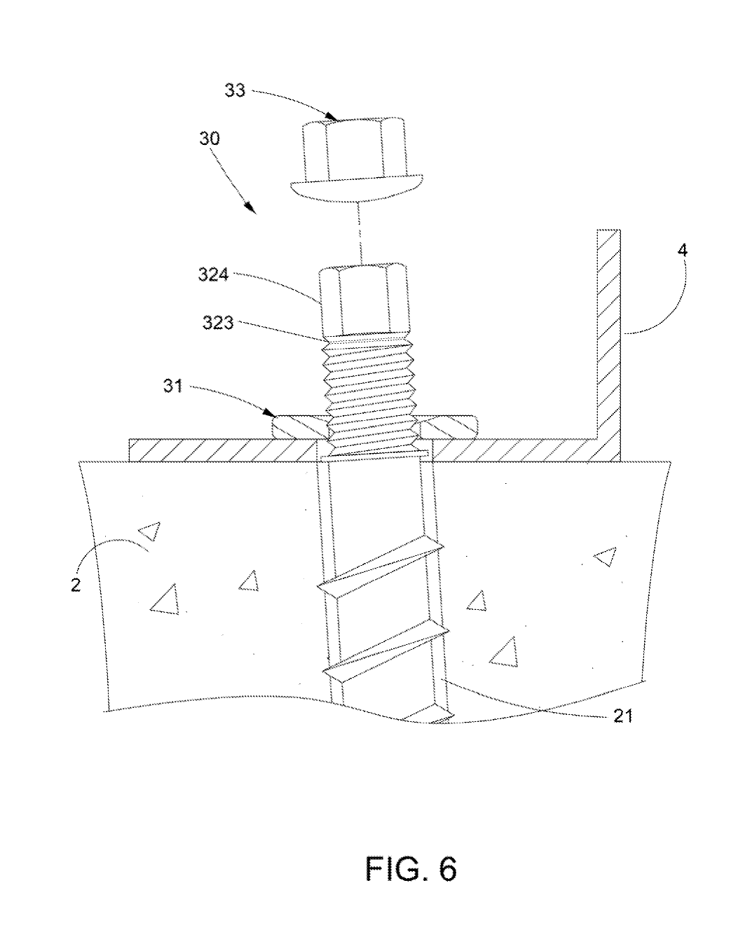

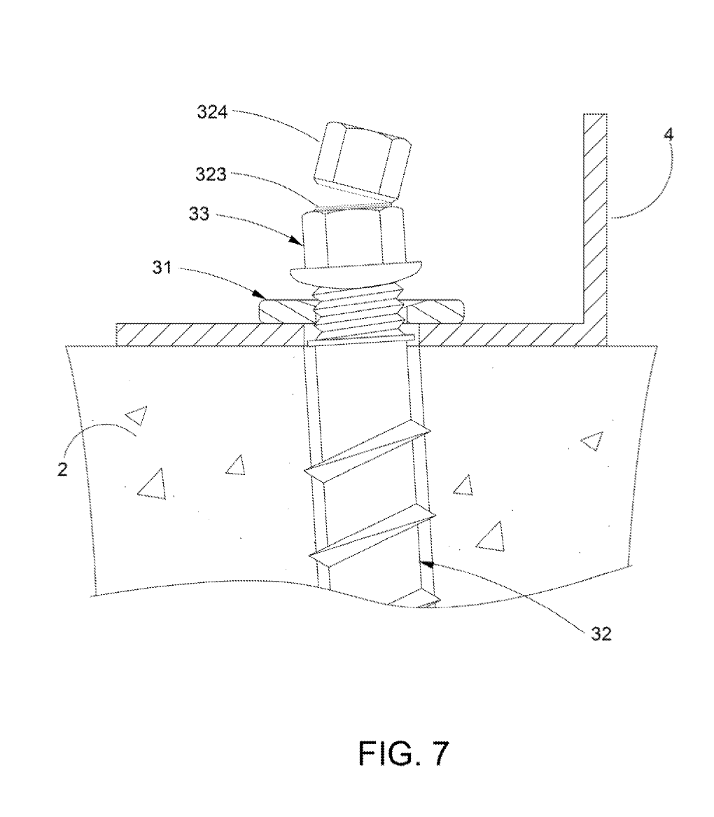

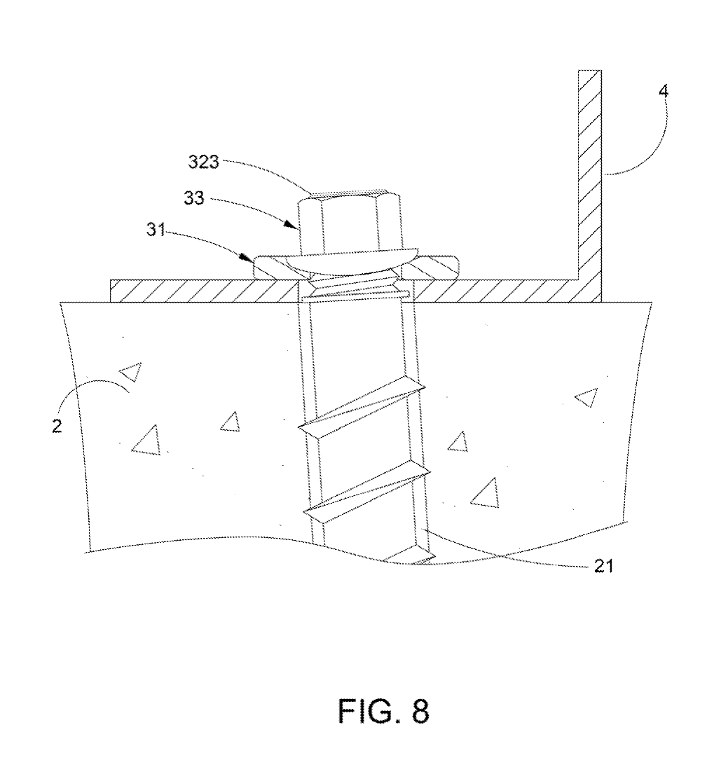

Referring to FIG. 5, a second preferred embodiment of the present invention is shown. The concrete bolt assembly 3 similarly comprises the bolt set 30 and the spherical washer 31 as that of the previous embodiment. Differently, the concrete bolt member 30 and the spherical nut 33 are separated in this embodiment. On the shank 321 of the concrete bole member 32, a neck 323 is formed opposite to the first threaded section 322, a polygonal section 324 is disposed above the neck 323, and a second threaded section 325 is surrounded between the first threaded section 322 and the neck 323. Further, the spherical nut 33 defines a threaded hole 334B around the center of the first, sphere 334A for coupling to the second threaded section 325. In this embodiment, the polygonal section 324 is directed to a hexagonal section that is commonly seen in practice. Moreover, a pitch d1 of the first threaded section 322 is larger than a pitch d2 of the second threaded section 325. Accompanying with FIGS. 6 to 8, a wrench (not shown) is utilized to rotate the polygonal (hexagonal) section 324 on the shank 321 so as to bring the first threaded section 322 getting into the predrilled hole 21. When the bolt set 30 is engaged properly, the polygonal (hexagonal) section 324 is snapped from the neck 323 (as shown in FIG. 7). In the meantime, the fastening of the concrete bolt assembly 3 is not completed yet. In order to complete the fastening of the concrete bolt assembly 3, the wrench further rotates the spherical nut 33, so that the spherical nut. 33 is able to move toward the spherical washer 31 until they are both stopped by the object 4. Accordingly, the concrete bolt member 32 is now firmly engaged in the predrilled hole 21, and the object 4 is tightly and stably locked onto the concrete 2.

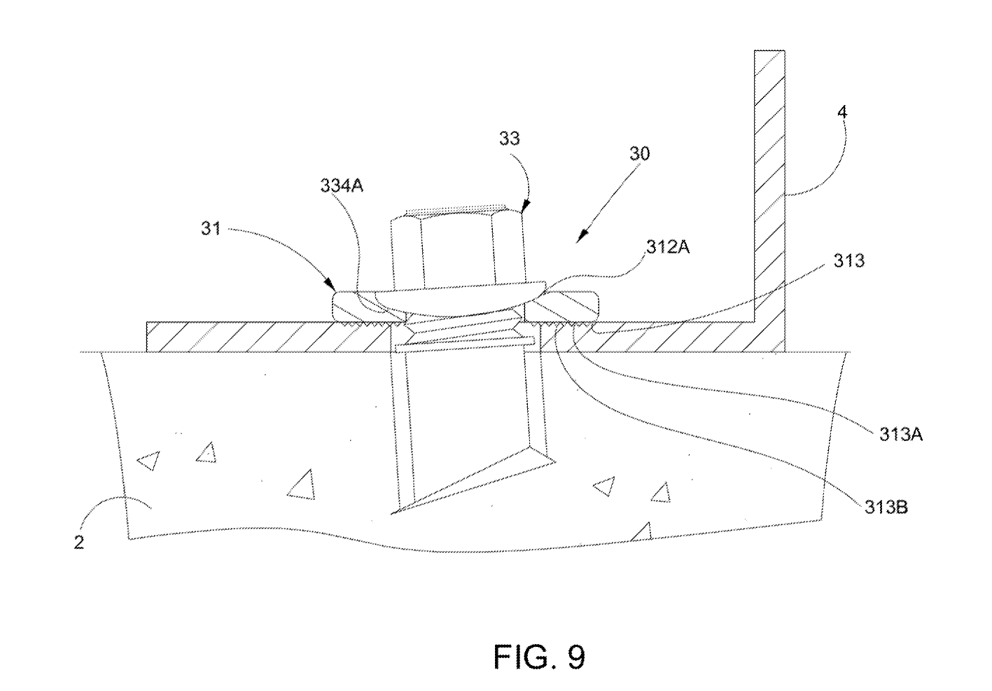

Referring to FIG. 9, a third preferred embodiment of the present invention is shown. The concrete bolt assembly 3 similarly comprises the concrete bolt member 32 and the spherical washer 31 as that of the previous embodiment. Differently, a plurality of slots 313A are defined on the second bottom plane 313 of the spherical washer 31, so that a periphery of the second bottom plane 313 is indented by forming a plurality of teeth units 313B thereon. Concurrently, a radian of the first, sphere 334A of the spherical nut 33 and a radian of the second sphere 312A of the spherical washer 31 are different. Accordingly, the teeth, units 313B of the spherical washer 31 increase resistance between the spherical washer 31 and the object 4, so that the concrete bolt assembly 3 is able to be more tightly engaged after screwed. Moreover, the different radians of the spherical washer 31 and the spherical nut 33 also augment friction therebetween, so that the spherical washer 31 and the spherical nut 33 can be more tightly clenched after screwed. Thereby, the concrete bolt assembly 3 does not easily come off the concrete 2.

To sum up, the present invention takes advantage of the first sphere of the spherical nut and the second sphere of the spherical washer to increase a contacting area therebetween. Namely, the spherical washer and the spherical nut can be tightly engaged in a perpendicular way even the concrete bolt assembly is fastened into the concrete by means of any inclined screwing angle. Accordingly, there is no interstice occurred after the spherical washer and the spherical nut assist the concrete bolt member in fastening. Therefore, the concrete bolt assembly can tightly and stably stay in the concrete, and the structure or the strength of the concrete will not be destroyed, Preferably, the embedded concrete bolt assembly will not be removed easily since it is prevented from external influence.

While we have shown and described the embodiment in accordance with the present invention, it should be clear to those skilled in the art that further embodiments may be made without departing from the scope of the present invention.

What is claimed is:

1. A concrete bolt assembly comprising:
a bolt set including a concrete bolt member and a spherical nut disposed on said concrete bolt member; wherein, said concrete bolt member having a shank, and a first threaded section disposed on said shank, opposite to said spherical nut; said spherical nut having a head portion formed with respect to a central axis, a first top plane formed on said head portion, and a first bottom plane formed opposite to said first top plane; said first bottom plane being formed into a first sphere configuration, and a center of said first sphere being situated on said central axis; and
a spherical washer disposed on said bolt set; said spherical washer having a washer body, a second top plane formed on said washer body, and a second bottom plane disposed opposite to said second top plane; wherein, an opening being defined on said washer body for said shank of said concrete bolt member to penetrate; a second sphere, corresponding to said first sphere, being formed on said second top plane, and a center of said second sphere being situated on said central axis.

2. The concrete bolt assembly as claimed in claim 1, wherein, said concrete bolt member and said spherical nut are separated; on said shank of said concrete bole member, a neck is formed opposite to said first threaded section, a polygonal section is disposed above said neck, and a second threaded section is surrounded between said first threaded section and said neck; said spherical nut defines a threaded hole around said center of said first sphere for coupling to said second threaded section.

3. The concrete bolt assembly as claimed in claim 2, wherein, said polygonal section is a hexagonal section,

4. The concrete bolt assembly as claimed in claim 2, wherein, a pitch of said first threaded section is larger than a pitch of said second threaded section.

5. The concrete bolt assembly as claimed in claim 3, wherein, a pitch of said first threaded section is larger than a pitch of said second threaded section.

6. The concrete bolt assembly as claimed in claim 4, wherein, a plurality of slots are defined on said second bottom plane of said spherical washer, so that a periphery of said second bottom plane is indented by forming a plurality of teeth units thereon.

7. The concrete bolt assembly as claimed in claim 5, wherein, a plurality of slots are defined on said second bottom plane of said spherical washer, so that a periphery of said second bottom plane is indented by forming a plurality of teeth units thereon.

8. The concrete bolt assembly as claimed in claim 4, wherein, a radian of said first sphere of said spherical nut and a radian of said second sphere of said spherical washer are different.

9. The concrete bolt assembly as claimed in claim 5, wherein, a radian of said first sphere of said spherical not and a radian of said second sphere of said spherical washer are different.
